(19) United States
(12) Patent Application Publication
(10) Pub. No.: US 2006/0024106 A1
(43) Pub. Date: Feb. 2, 2006

(54) High speed serial printing using meters

(76) Inventor: James M. Mattern, Bethany, CT (US)

Correspondence Address: PERMAN & GREEN, 425 POST ROAD, FAIRFIELD, CT, 06824, US

(21) Appl. No.: 11/191,091

(22) Filed: Jul. 27, 2005

Related U.S. Application Data
(60) Provisional application No. 60/591,393, filed on Jul. 27, 2004.

(51) Int. Cl. B41J 29/38; B41J 13/00

(52) U.S. Cl. 400/76; 100/45; 400/578

(57) ABSTRACT

A printing system includes a printing media transport for transporting printing media along a media path, a plurality of meters arranged serially along the media path, and a processor for controlling the printing media transport and for allocating printing information among the plurality of meters.

This application claims the benefit of U.S. Provisional Application No. 60/591,393 filed Jul. 27, 2004 which is incorporated by reference herein in its entirety.

### BACKGROUND

The exemplary embodiments described herein relate to a printing device for high speed printing using serially arranged meters.

### BRIEF DESCRIPTION OF RELATED DEVELOPMENTS

Mailing machines or meters enable users to frank one or more mail items by printing a stamp representing the amount paid by the sender. For example, U.S. Pat. Nos. 5,243,908; 5,683,190; 5,526,271; 6,607,095; 6,050,054; 5,293,465; 5,688,729; all of which are incorporated herein by reference in their entirety; disclose franking machines which may comprise franking heads, feeders, folders and user interfaces as examples.

Barcoded indicia generally occupies about 1 square inch, may require 2 pens and 1 printhead to print, and may require a resolution of approximately 300 DPI. Alignment among multiple devices such as pens and printheads can be difficult to achieve and maintain.

Furthermore, the printing devices themselves within a meter generally print at a rate much slower than typical media transport speeds. For example, a typical printhead may be capable of printing 300 DPI on media travelling at a maximum of 55 inches/second. Using envelopes as an example, this translates to approximately 15 thousand envelopes/hour. Typical media transport devices are capable of moving media at much faster speeds.

It would be advantageous to create a system that is capable of printing at speeds faster than presently available.

### SUMMARY OF THE EXEMPLARY EMBODIMENTS

In accordance with one exemplary embodiment of the present invention, a printing system includes a printing media transport for transporting printing media along a media path, a plurality of meters arranged serially along the media path, and a processor for controlling the printing media transport and for allocating printing information among the plurality of meters.

In accordance with another exemplary embodiment of the present invention, a mail piece printing system includes a mail piece transport for transporting mail pieces along a media path, a plurality of postage meters arranged serially along the media path, and a processor for controlling the mail piece transport and for allocating postage information among the plurality of postage meters.

### BRIEF DESCRIPTION OF THE DRAWINGS

The foregoing aspects and other features of the present invention are explained in the following description, taken in connection with the accompanying drawings, wherein:

FIG. 1 shows a block diagram of a system according to the exemplary embodiment; and

FIG. 2 shows a block diagram of a processor for controlling the system.

### DETAILED DESCRIPTION OF THE EXEMPLARY EMBODIMENTS

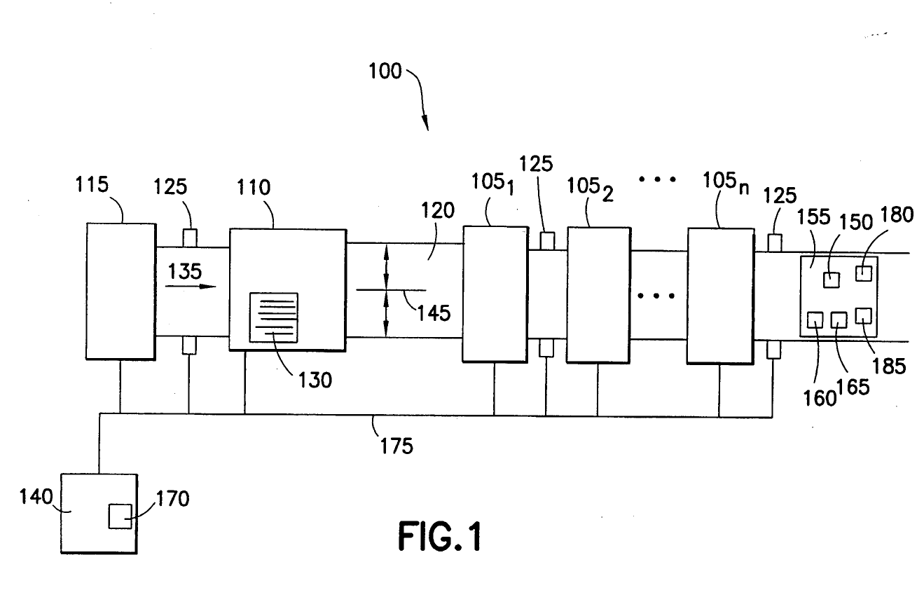

FIG. 1 shows a schematic block diagram of a printing system 100 suitable for practicing the invention disclosed herein and incorporating features in accordance with the exemplary embodiments of the present invention. Although the present invention will be described with reference to the exemplary embodiments shown in the drawings, it should be understood that the present invention can be embodied in many alternate forms of embodiments. In addition, any suitable size, shape or type of elements or materials could be used.

In the exemplary embodiment shown, system 100 may comprise a printing system or mailing machine utilizing meters 105₁, 105₂, . . . 105ₙ for printing on media. The printing media may, for example, include mail items and the meters 105₁, 105₂, . . . 105ₙ may be postage meters controlled to print a postage mark or other indicia on the mail items. In alternate embodiments, any other suitable printing application may be provided.

The printing system or mailing machine 100 may have a printing media buffer 110, a printing media inserter 115, and a media path 120. The meters 105₁, 105₂, . . . 105ₙ may be positioned, for example, serially along the media path 120. The system 100 device may also include a printing media transport 125 adapted to transport the printing media along the media path 120.

The printing media inserter 115 allows introduction of printing media into system 100. The printing media inserter 115 may transfer the printing media 130 to the media path 120, to the printing media buffer 110, or from the printing media buffer 110 into the media path 120. The media transport 125 feeds the printing media 130 along the media path 120 in a media feed direction 135 at a desired media feed speed. The media feed speed may be fixed or variable and may be controlled by a processor 140. In one embodiment, the media feed speed is one speed when the printing media is being printed upon by a meter and is a second speed when no meter is printing. The printing media 130 traveling along the media path 120 is sequentially printed upon by each of, one of, or more than one of, meters 105₁, 105₂, . . . 105ₙ The printing media may include, for example, envelopes, folders, printed sheets, or other types of mail pieces.

Meters 1051, 1052, . . . 105, are shown in FIG. 1 for example purposes, although any suitable number of meters 105 may be utilized. The meters 105₁, 105₂, . . . 105ₙ are arranged serially along the media path 120 and may be at a common pitch or at different pitches and may overlap or coincide with each other. In addition, the meters 105₁, 105₂, . . . 105ₙ may be staggered with respect to a centerline 145 of the media path 120. Similarly, a print area of each meter 105 may be at a common pitch or at different pitches, may overlap or coincide with each other, and may be staggered with respect to the centerline 145 of the media path 120.

The printing media buffer 110, printing media inserter 115, media transport 125, media path 120, and meters 105₁, 105₂, . . . 105ₙ are controlled from the processor 140 for optimum printing media throughput. The processor 140 may direct or apportion printing information or data 170 to meters 105₁, 105₂, . . . 105ₙ where meters 105₁, 105₂, . . . 105ₙ may share printing information or data 170 representing a predetermined image 150 printed upon an individual media piece 155. Alternately, different information may be printed on each individual media piece.

In another embodiment, the processor 140 may direct or apportion the printing information 170 to meters 105₁, 105₂, . . . 105ₙ where meters 105₁, 105₂, . . . 105ₙ may share printing information 170 representing multiple images 160, 165 to be printed upon an individual media piece or separately directed to separate media pieces. In yet another embodiment, printing information 170 may be processed and directed generally to meters 105₁, 105₂, . . . 105ₙ to be placed on media pieces in any suitable combination. In this manner, printing information may be dynamically allocated among the meters 105₁, 105₂, . . . 105ₙ according to various system parameters that may be predetermined or dynamic, for example, meter capability, printable colors in a meter, printhead resolution in a meter, media piece position, media type, media speed, meter printing speed or any other suitable parameter, in order to achieve optimum throughput.

The speed of the printing media inserter 115, printing media buffer 110, media path transport 125, and media path 120 may be controlled in conjunction with the information sent to each meter 105₁, 105₂, . . . 105ₙ in order to achieve optimum throughput. The media path 120 may travel at a variable speed or at a constant speed depending on a variable set point of media path transport 125. The processor 140, printing media inserter 115, printing media buffer 110, media path 120, media path transport 125, and meters 105₁, 105₂, . . . 105ₙ may communicate with each other over a communication path or network 175.

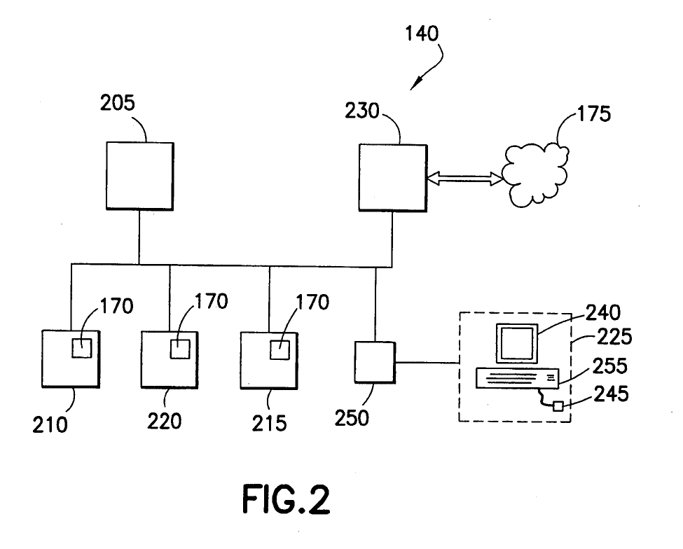

FIG. 2 shows a block diagram of the processor 140. The controller generally includes a controller 205, read only memory 210, random access memory 215, program storage 220, a user interface 225, and a network interface 230.

Controller 205 is generally operable to read information and programs from a computer program product, for example, a computer useable medium, such as read only memory 210, random access memory 215, or program storage 220.

Both read only memory 210 and random access memory 215 may utilize semiconductor technology or any other appropriate materials and techniques. Program storage 220 may include a diskette, a computer hard drive, a compact disk, a digital versatile disk, an optical disk, a chip, a semiconductor, or any other device capable of storing programs in the form of computer readable code.

Read only memory 210, random access memory 215, and program storage 220, either individually or in any combination may include operating system programs for controlling the printing media inserter 115, printing media buffer 110, media path transport 125, media path 120, and meters 105₁, 105₂, . . . 105ₙ according to the embodiments disclosed herein. Read only memory 210, random access memory 215, and program storage 220, either individually or in any combination may also store the printing information or data 170.

The network interface 230 may be generally adapted to provide an interface between the processor 140 and the components of system 100 through the communication path or network 175. Communication path 175 may include the Public Switched Telephone Network (PSTN), the Internet, a wireless network, a wired network, a Local Area Network (LAN), a Wide Area Network (WAN), a virtual private network (VPN) etc., and may further include other types of networks including X.25, TCP/IP, ATM, etc. In one embodiment, communication path 175 may be an IEEE 1349 network, also referred to as a “Firewire” network.

The user interface 225 includes a display 240 and an input device such as a keyboard 255 or mouse 245. The user interface may be operated by a user interface controller 250 under control of controller 205.

Returning to FIG. 1, the printing media 130 traveling along the media path 120 may be printed upon sequentially or in parallel by at least two meters 105. As noted previously, system 100 may include a printing system or a mailing machine and the printing media 130 may include mail where the meters 105₁, 105₂, . . . 105ₙ are controlled to print a postage mark or other postage information 180 and where the media path includes a stream of mail pieces (e.g. media 155) moved by media transport 125 along the media path 120 across the meters 105₁, 105₂, . . . 105ₙ. In one embodiment, the media transport may be a mail piece transport mechanism specifically adapted to transport mail pieces along the media path 120 and the processor may allocate the postage information 180 among the meters 105₁, 105₂, . . . 105ₙ.

A velocity of the printing media 130 along the media path 120 may be set as desired. For example, the difference between the mail stream or media speed (i.e. speed of media path 120) and meter printing speed for a given meter 105 may be established to be substantially equivalent to a desired print speed for a desired print resolution for the given meter 105. Thus as may be realized, system 100, in effect may decouple the media speed from the print resolution of a given meter 105, or may enable the print speed of the meter 105 to be independent of media speed. In this embodiment, each meter 105₁, 105₂, . . . 105ₙ may be able to print over a portion of a piece of media or over multiple pieces of media.

In this embodiment, one or more of the meters 105₁, 105₂, . . . 105ₙ may be movable outside the media path 120 such as for servicing. Also in this embodiment, the meters 105₁, 105₂, . . . 105ₙ may be controlled to allow at least one of the meters to be inactivated for service while the remaining meters are active. In this embodiment, the media throughput may be selectively reduced or remain constant depending on the availability of the remaining active meters 105₁, 105₂, . . . 105ₙ. In an exemplary embodiment, processor 140 may control meters 105₁, 105₂, . . . 105ₙ to allow at least one of the meters to be inactivated for servicing, such as for cleaning or replacement while the remaining meters are active.

Meters 105₁, 105₂, . . . 105ₙ may have a variable number of printheads for printing, for example, a black and a color printhead. In alternate embodiments, more or less printheads could be provided with each meter, such as simply a monochrome color. Each or all of the printheads may be capable of printing the same color or combination of colors. Alternately, printheads may print different colors or be provided in combinations of groups with the same or different colors. For example, the printheads may all be monochrome or black. Alternately, the printheads may all be combination color and black. Colors, for example may be Cyan, Yellow and Magenta or Multiple Cyan, Multiple Yellow and Multiple Magenta or RGB or individual or multiple colors. Alternately, printheads of the same or varying colors may be combined in any suitable combination.

The meters 105₁, 105₂, . . . 105ₙ may be controlled to enable a higher print resolution than the maximum print resolution of any single meter 105. In one embodiment, the meters 105₁, 105₂, . . . 105ₙ may be controlled to share data representing a predetermined image where the meters 105₁, 105₂, . . . 105ₙ sequentially print interlaced images resulting in the predetermined image on a piece of printing media 130. The higher print resolution may be the product of the desired or maximum print resolution and the number of meters 105₁, 105₂, . . . 105ₙ utilized to create the predetermined image of predetermined resolution. Each of the meters employed to make the predetermined image of predetermined resolution may be capable of printing the same color or combination of colors.

The print resolution of one or more meters 105₁, 105₂, . . . 105ₙ may be fixed or may be adjustable. A piece of the printing media 130 traveling along the media path 120 in the media feed direction 135 may be printed upon by more than one of the meters 105₁, 105₂, . . . 105ₙ to generate image 36 on the piece. In an exemplary embodiment, the meters 105₁, 105₂, . . . 105ₙ printing on the printing media piece and the media path transport 125 are controlled by processor 140 to enable a higher media feed speed than, for example, a media feed speed supported by stationary meters 105 capable of a predetermined print resolution for an image of a predetermined resolution. As the printing media 130 travels along the media path 120, images from separate meters 105₁, 105₂, . . . 105ₙ printing on the printing media 130 may be interlaced to produce image 150 or image 180. Thus, for example, the predetermined resolution of the combined printing may, be the same as or higher than the maximum print resolution capability of any one of the meters 105₁, 105₂, . . . 105ₙ.

A certain number of the meters 105₁, 105₂, . . . 105ₙ may be actively printing at 100 DPI (˜3.5M/S) where the dots are interlaced to form a 300 DPI combined print image 185 on piece 155. In this embodiment, each meter, for example, may print at 100 DPI; a 300 DPI data matrix may be split among 3 meters. As a further illustration, each meter may print at a reduced resolution. For example, a meter with an unreduced print resolution of 300 DPI may be operated to print at 150 DPI, with a corresponding increase in print speed and desired media feed speed. Throughput may be increased even further by sharing information among meters such that each meter prints at, for example, 150 DPI, but the effective resolution of the finally printed media piece is 300 DPI where the printed images are interlaced. For example, if a single meter 105 is capable of printing 15 K/HR @ 300 DPI, then the combined effect of four meters may print 60K/HR @ 300 DPI.

It should be understood that the foregoing description is only illustrative of the invention. Various alternatives and modifications can be devised by those skilled in the art without departing from the invention. One such example is where other configurations of printheads may also be used. Accordingly, the present invention is intended to embrace all such alternatives, modifications and variances which fall within the scope of the appended claims.

What is claimed is:

1. A printing system comprising:
a printing media transport for transporting printing media along a media path;
a plurality of meters arranged serially along the media path; and
a processor for controlling the printing media transport and for allocating printing information among the plurality of meters.

2. The printing system of claim 1, wherein the printing media traveling along the media path is printed upon sequentially by each of the plurality of meters, and wherein the printing media transport and the meters are controlled for optimum printing media throughput.

3. The printing system of claim 1, wherein the printing media traveling along the media path is printed upon by an individual one of the plurality of meters, and wherein the printing media transport and the meters are controlled for optimum printing media throughput.

4. The printing system of claim 1, wherein the printing media transport is controlled such that the printing media travels at a first speed when printed upon by at least one of the plurality of meters and travels at a second speed when the printing media is not being printed upon.

5. The printing system of claim 1, wherein the processor allocates printing information according to predetermined or dynamic system parameters.

6. The printing system of claim 1, wherein the printing media comprises mail and wherein the plurality of meters are controlled to print a postage mark.

7. The printing system of claim 1 wherein the plurality of meters are controlled to allow at least one of the plurality of meters to be inactivated for servicing while at least one other meter is active, and wherein media throughput may be selectively reduced or remain constant depending on the availability of the other active meter.

8. A mail piece printing system comprising:
a mail piece transport for transporting mail pieces along a media path;
a plurality of postage meters arranged serially along the media path; and
a processor for controlling the mail piece transport and for allocating postage information among the plurality of postage meters.

9. The mail piece printing system of claim 8, wherein the mail pieces traveling along the media path are printed upon sequentially by each of the plurality of postage meters, and wherein the mail piece transport and the postage meters are controlled for optimum mail piece throughput.

10. The mail piece printing system of claim 8, wherein the mail pieces traveling along the media path are printed upon by an individual one of the plurality of postage meters, and wherein the mail piece transport and the postage meters are controlled for optimum mail piece throughput.

11. The mail piece printing system of claim 8, wherein the mail piece transport is controlled such that the mail pieces travel at a first speed when printed upon by at least one of the plurality of postage meters and travel at a second speed when the mail pieces are not being printed upon.

12. The mail piece printing system of claim 8, wherein the processor allocates postage information according to predetermined or dynamic system parameters.

13. The mail piece printing system of claim 8 wherein the plurality of postage meters are controlled to allow at least one of the plurality of postage meters to be inactivated for servicing while at least one other postage meter is active, and wherein mail piece throughput may be selectively reduced or remain constant depending on the availability of the other active meter.
